(19) United States
(12) Patent Application Publication
(10) Pub. No.: US 2007/0099143 A1
(43) Pub. Date: May 3, 2007

(54) Non-anesthetic dental cleaning for animals

(76) Inventor: Charles Don Purkey, Costa Mesa, CA (US)

Correspondence Address: CHARLES C.H. WU, 98 DISCOVERY, IRVINE, CA, 92618-3105, US

(21) Appl. No.: 11/265,697

(22) Filed: Nov. 2, 2005

(51) Int. Cl. A61D 5/00

(52) U.S. Cl. 433/1

(57) ABSTRACT

A method for teeth cleaning without using anesthetics can be conducted on animals having teeth and movable jaws. A human operator uses their hand to expose animal teeth for cleaning. The teeth are cleaned by touching the teeth with an elongated member having a hard tip.

### BACKGROUND OF THE INVENTION

1. Field of the Invention

The invention pertains to the field of dental cleaning. More particularly, the invention pertains to a non-anesthetic dental cleaning method and system for animals.

2. Description of Related Art

Dental cleaning is known. U.S. Pat. No. 6,514,077 to Wilk discloses a method for dental plaque removal intended for consumer use which comprises filling the mouth with a physiologically acceptable cleaning solution, solvent, or wash, holding such solution in the mouth under voluntary muscular control, thereafter inserting through the lips an elongate acoustically excitable probe forming, under muscular control, a seal with the lips. The probe is energized and a sonic or ultrasonic cleaning action in the mouth removes incipient plaque deposits from the teeth, without the necessity of visiting each tooth individually with a manual or partially automatic mechanical cleaning implement, such as a toothbrush. In an alternative embodiment, fluid fill is provided through a channel in the probe and filling of the mouth is accomplished following insertion. The method may be used in a more general sense to acoustically clean articles in a flexible portable enclosure by means of a portable probe or tool.

However, teeth, under certain circumstances, may still need to be cleaned individually. For example, plaque on certain teeth sometimes still needs scratching for their removal. Traditionally, for animals, anesthetics are applied for ease of cleaning due to the possible reactions from the animals such as biting, etc. The use of anesthetics can be elaborate and may have an adverse effect upon the animals. Therefore, a non-anesthetic dental cleaning method and system for animals is desirable.

### SUMMARY OF THE INVENTION

A non-anesthetic dental cleaning method and system for animals is provided.

A method for teeth cleaning without using anesthetics can be conducted on animals having teeth and movable jaws. A human operator uses their hand to expose animal teeth for cleaning. The teeth are cleaned by touching the teeth with an elongated member having a hard tip.

### BRIEF DESCRIPTION OF THE DRAWING

FIG. 1 shows a method of the present invention.

FIG. 2 shows the location for placing operator's finger while applying the present invention.

### DETAILED DESCRIPTION OF THE INVENTION

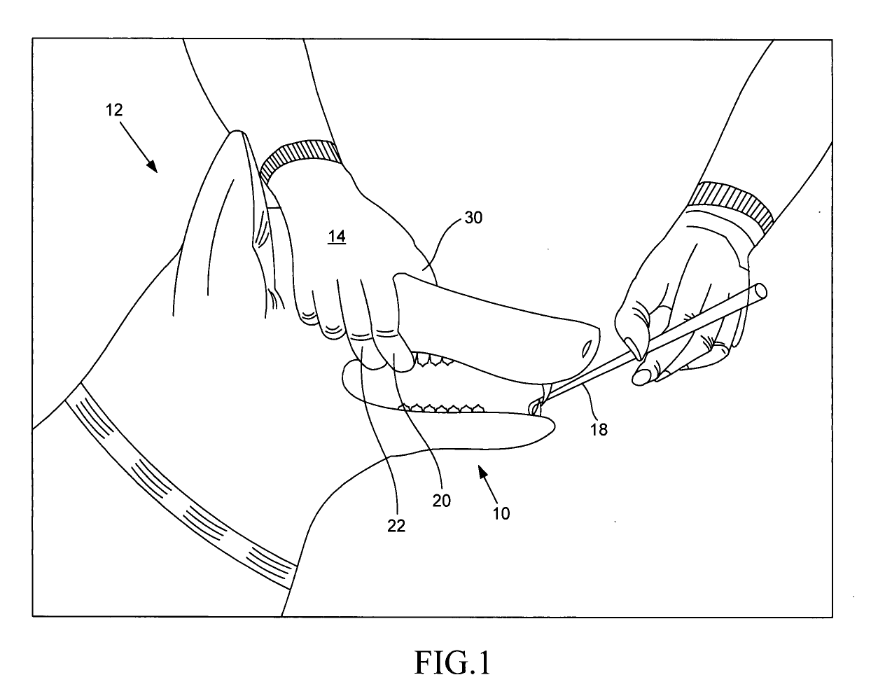

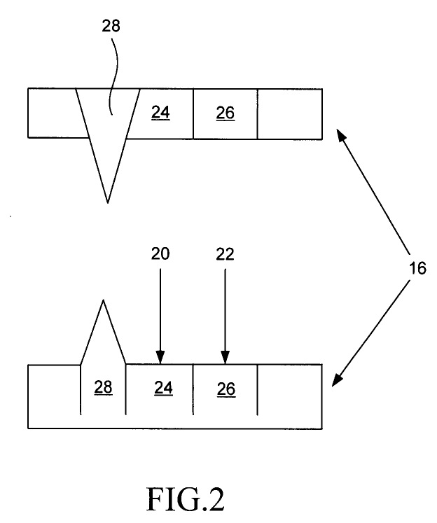

Referring to FIGS. 1-2, part of an animal such as the muzzle portion 10 of a dog 12 is shown. Dog 12 has at least some teeth and a movable jaw. A human operator having a pair of hands (only one hand 14 shown) is used to clean the teeth 16 of dog 12. Dog 12 has lips that cover the dog's teeth 16. Hand 14 is used to secure the dog 12 and expose the teeth 16 behind the lips for dental cleaning using known tools such as scraper 18. Muzzle portion 10 may be manipulated by the other hand of the pair of hands.

Securing to the dog 12 may be done by way of holding the muzzle portion 10. For example, hand 14 holds the upper portion of the mouth as shown. Alternatively, hand 14 may hold the lower portion of the mouth from below (not shown). A second operator may use scraper 18 for cleaning the teeth 16 of the dog 12. One or more fingers of the hand 14 may be placed inside the mouth of the dog 12 in order to keep the teeth 16 exposed for cleaning and related operations. For example, the index finger 20 and/or middle finger 22 of the hand 14 may be placed within the mouth of the dog 12 between the teeth 16. The purpose of placing fingers somewhat within the mouth is to expose teeth 16 for cleaning or plaque removal.

To prevent the teeth 16 from clumping down upon the fingers, the human hand 14 should not extend too far into the area between the teeth 16. By way of an example, the index finger 20 and/or middle finger 22 may be placed between the first molars 24 and/or the second molars 26 of the teeth 16 behind the canine teeth 28. Alternatively, if the inside of teeth 16 can be cleaned without placing the fingers between teeth 16, it is generally advisable not to do so. In order to hold or secure the mouth, the thumb 30 of the hand 14 is placed on the opposite side of the muzzle portion 10 for securing the same for teeth cleaning.

As can be seen, FIG. 1 shows the cleaning of one side of teeth 16. The other side of teeth 16 can be cleaned under similar conditions. In other words, the index finger 20 and/or middle finger 22 are placed on the opposite side of the mouth using a similar method of cleaning discussed supra. The cleaning of the teeth 16 is done using known methods. The index finger 20 and/or middle finger 22 may be placed further behind the canine teeth on the gum area of the dog 12. Thereby, before teeth 12 bites down, a human operator (only her hand 14 shown) can detect an indication such as a directional movement of the gum indicating the start of the biting down, therefore moving the fingers away accordingly.

The dog 12 may be bodily restrained by the human operator's two legs with the operator sitting on a flat surface. Alternatively, other means of restraint using known or unknown methods may be used. A piece of absorbent cloth may be applied upon the periphery of teeth 16 to absorb extra saliva before or during cleaning. Sometimes, before cleaning some portions of teeth 16, an elongated member may be required to ply open the clumped teeth 16 between teeth 16. Therefore cleaning can be performed with ease.

Further, a dog 12 is shown in FIG. 1. However, other types of animals' teeth cleanings are contemplated by the present invention's method and system of teeth cleaning.

The following is a method for cleaning an animal's teeth without the application of anesthetics. From over the animal's mouth, a human hand holding open the mouth of the animal via the animal's upper jaw (lip) with only the thumb at one end positioned within the mouth. The thumb is placed on the first molar behind the canine tooth (which is adjacent to the first molar). Similarly, from under the mouth, the index or middle finger of the right hand is placed similarly on the opposite molars behind the opposite canine tooth. The other hand of the human that holds an elongated member with a sharp semi-hooked end scrapes the inner side of the animal's teeth.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for teeth cleaning comprising the steps of:
providing an animal having teeth and movable jaws;
using a hand of a human operator to expose animal teeth for cleaning;
touching the teeth with an elongated member having a hard tip.

2. The method of claim 1 further comprising extending one finger into one side of the movable jaws.

3. The method of claim 1 further comprising extending one finger into one side of the movable jaws touching the gum portion.

4. The method of claim 1 further comprising using a pair of feet of the human operator to secure the animal.
